(19) United States
(12) Patent Application Publication
(10) Pub. No.: US 2008/0156876 A1
(43) Pub. Date: Jul. 3, 2008

(54) Illumination system including convex/concave lens for an imaging-based bar code reader

(75) Inventor: Igor Vinogradov, New York, NY (US)

Correspondence Address: TAROLLI, SUNDHEIM, COVELL & TUMMINO L.L.P., 1300 EAST NINTH STREET, SUITE 1700, CLEVEVLAND, OH, 44114, US

(73) Assignee: SYMBOL TECHNOLOGIES, INC., Holtsville, NY (US)

(21) Appl. No.: 11/647,887

(22) Filed: Dec. 29, 2006

(51) Int. Cl. G06K 7/10

(52) U.S. Cl. 235/462.01

(57) ABSTRACT

An illumination apparatus for an imaging-based bar code reader including an illumination source directing illumination through a focusing lens to generate an illumination pattern directed toward a target object; and the focusing lens including a first optical surface facing the illumination source and a second optical surface facing the target object. The first optical surface, when viewed with respect to the lens horizontal axis, includes a central region having concave curvature and peripheral regions spaced on opposite sides of the central region having convex curvature such that the generated illumination pattern includes variation in illumination intensity projected toward the target object, namely, a central portion of the illumination pattern has relatively lower illumination intensity and outer peripheral portions of the illumination pattern on opposite sides of the central portion have relatively greater illumination intensity.

### FIELD OF THE INVENTION

The present invention relates to an illumination system for an imaging-based bar code reader and, more particularly, to an illumination system for an imaging-based bar code reader including an illumination source and a focusing lens having an optical surface facing the illumination source, the focusing lens having convex and concave curvature portions for generating an illumination pattern having variation in illumination intensity.

### BACKGROUND ART

Various electro-optical systems have been developed for reading optical indicia, such as bar codes. A bar code is a coded pattern of graphical indicia comprised of a series of bars and spaces of varying widths, the bars and spaces having differing light reflecting characteristics. Some of the more popular bar code symbologies include: Uniform Product Code (UPC), typically used in retail stores sales; Code 39, primarily used in inventory tracking; and Postnet, which is used for encoding zip codes for U.S. mail. Bar codes may be one dimensional (1D), i.e., a single row of graphical indicia such as a UPC bar code or two dimensional (2D), i.e., multiple rows of graphical indicia comprising a single bar code.

Systems that read bar codes (bar code readers) electro-optically transform the graphic indicia into electrical signals, which are decoded into alphanumerical characters that are intended to be descriptive of the article or some characteristic thereof. The characters are then typically represented in digital form and utilized as an input to a data processing system for various end-user applications such as point-of-sale processing, inventory control and the like.

Bar code readers that read and decode bar codes employing imaging systems are typically referred to as imaging-based bar code readers or bar code scanners. Imaging systems include charge coupled device (CCD) arrays, complementary metal oxide semiconductor (CMOS) arrays, or other imaging pixel arrays having a plurality of photosensitive elements (photosensors) or pixels. An illumination apparatus or system comprising light emitting diodes (LEDs) or other light source directs illumination toward a target object, e.g., a target bar code. Light reflected from the target bar code is focused through a system of one or more lens of the imaging system onto the pixel array. Thus, the target bar code within a field of view (FV) of the imaging lens system is focused on the pixel array.

Periodically, the pixels of the array are sequentially read out generating an analog signal representative of a captured image frame. The analog signal is amplified by a gain factor and the amplified analog signal is digitized by an analog-to-digital converter. Decoding circuitry of the imaging system processes the digitized signals representative of the captured image frame and attempts to decode the imaged bar code.

As mentioned above, imaging-based bar code readers typically employ an illumination apparatus to flood a target object with illumination from a light source such as a light emitting diode (LED) in the reader. Light from the light source or LED is reflected from the target object. The reflected light is then focused through the imaging lens system onto the pixel array, the target object being within a field of view of the imaging lens system.

The illumination system is designed to direct a pattern of illumination toward a target object such that the illumination pattern approximately matches the field of view (FV) of the imaging system. One problem with prior art illumination systems is that of non-uniformity of illumination intensity within the FV of imaging system. Generally, in prior art illumination systems, the intensity of illumination is greatest in a central area or portion of the illumination pattern, while the outer or fringe areas of the illumination pattern have a reduced illumination intensity. Compounding this problem of prior art illumination systems is the fact that the imaging lens system lens typically tends to collect and focus a greater portion of reflected light from a central area of the FV onto the pixel array than is collected and focused from the fringe areas FV because of, among other things, light attenuation towards the edge of the FV in accordance with at least the cosine in the third power law.

The non-uniformity of the illumination pattern combined with non-uniformity of imaging system focusing results in non-uniformity of light intensity across the pixels of the photosensor or pixel array as a function of pixel position, i.e., pixels corresponding to outer portions of the FV receive a lower intensity of reflected light than pixels in a central region of the pixel array. This tends to cause changes or fluctuation of the output analog signal read out from the pixel array based on the relative position of a pixel in the pixel array. Non-uniformity of the analog signal reduces the dynamic range of the imaging system and compromises reader performance.

What is needed is an illumination system generating an illumination pattern having a variation in illumination intensity such that a central area or portion of the illumination pattern has relatively less illumination intensity and outer peripheral areas or portions of the illumination pattern have relatively greater illumination intensity resulting in a more uniform intensity of reflected light focused on the pixel array of the imaging system.

### SUMMARY

In one aspect, the present invention features an illumination apparatus for an imaging-based bar code reader including an illumination source directing illumination through a focusing lens to generate an illumination pattern directed toward a target object and the focusing lens including a first optical surface. The first optical surface includes a central region or area having concave curvature defining a negative optical power and peripheral regions or areas spaced on opposite sides of the central region having convex curvature defining a positive optical power such that the generated illumination pattern includes variation in illumination intensity.

The generated illumination pattern includes variation in illumination intensity projected toward the target object such that a central portion of the illumination pattern has relatively lower illumination intensity and outer peripheral portions of the illumination pattern on opposite sides of the central portion have relatively higher illumination intensity. In one embodiment, the first optical surface of the focusing lens faces the illumination source and a second optical surface of the focusing lens faces the target object.

In one aspect, the present invention features an imaging-based bar code reader including an imaging system including a sensor array. In one exemplary embodiment, the sensor array is a linear sensor array for imaging one dimensional (1D) bar codes. The reader further includes an illumination apparatus or system for generating an illumination pattern having variation in illumination intensity projected toward a target object such that a central portion of the illumination pattern has relatively lower illumination intensity and outer peripheral portion of the illumination pattern on either side of the central portion have relatively greater illumination intensity resulting in a more uniform intensity of reflected light focused on the photosensor array of the imaging system.

In one aspect, the illumination system includes one or more LEDs which are focused through a focusing lens to generate an illumination pattern, an optical surface of the lens facing the one or more LEDs includes a central region or area having concave curvature defining a negative optical power and peripheral regions or areas spaced on either side of the central region having convex curvature defining a positive optical power. This results in an illumination pattern in which an illumination intensity of the peripheral areas on either side of the central portion exceeds an illumination intensity of the central portion.

In one embodiment, an optical surface of the lens facing the target is an aspherical cylindrical surface having a back or rear focal plane congruent with an aperture disposed between the LEDs and the focusing lens. A vertical size or dimension of the aperture determines the vertical extent of the illumination pattern. Depending on the illumination requirements of the target object to be imaged, one or more illumination lens and corresponding LEDs may be utilized in the illumination system.

In one exemplary embodiment, the illumination system includes first and second assemblies, each of which include an illumination source and a focusing lens, the first assembly being on one side of the optical axis of the imaging system and the second assembly being on the opposite side of the optical axis of the imaging system. For each of the first and second assemblies, a center point of the focusing lens is offset from a center point of the illumination source resulting in an illumination pattern including a central area and outer peripheral areas on opposite sides of the central area wherein one of the outer peripheral area receives relative greater illumination intensity from the first assembly and the other of the outer peripheral areas receives a greater illumination intensity from the second assembly.

These and other objects, advantages, and features of the exemplary embodiments are described in detail in conjunction with the accompanying drawings.

### BRIEF DESCRIPTION OF THE DRAWINGS

The foregoing and other features and advantages of the present invention will become apparent to one skilled in the art to which the present invention relates upon consideration of the following description of the invention with reference to the accompanying drawings, in which:

FIG. 1 is a schematic side elevation view of an exemplary embodiment of an imaging-based bar code reader of the present invention;

FIG. 2 is a schematic front elevation view of the bar code reader of FIG. 1;

FIG. 3 is a schematic top plan view of the bar code reader of FIG. 1;

FIG. 4 is a schematic view partly in section and partly in side elevation of a camera assembly of an imaging assembly of the bar code reader of FIG. 1;

FIG. 5 is a schematic block diagram of the bar code reader of FIG. 1;

FIG. 6 is a schematic perspective view of an illumination apparatus of the present invention;

FIG. 7 is a schematic top plan view of the illumination apparatus of FIG. 6;

FIG. 8 is a graph of illumination intensity as a function of horizontal position along a horizontal axis of the illumination pattern generated by the illumination apparatus of FIG. 6;

FIG. 9 is a schematic representation of illumination intensity of the illumination pattern generated by the illumination apparatus of FIG. 6;

FIG. 10 is a schematic front elevation view of a bar code reader utilizing a second exemplary embodiment of an illumination apparatus;

FIG. 11 is a schematic top view of the illumination apparatus of FIG. 10

FIG. 12 is a schematic perspective view of one of the focusing lens of the illumination apparatus of FIG. 10;

FIG. 13 is a schematic top view of the focusing lens of FIG. 12; and

FIG. 14 is an enlarged schematic top view of the focusing lens of FIG. 12 showing the regions of positive and negative residual sag.

### DETAILED DESCRIPTION

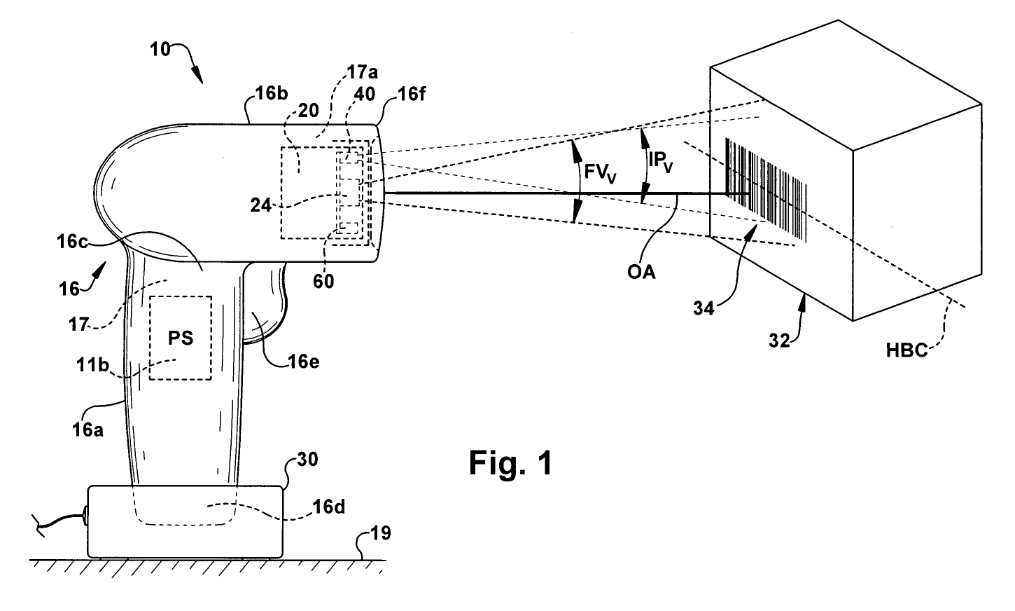

An exemplary embodiment of an imaging-based bar code reader of the present invention is shown schematically at 10 in FIGS. 1-5. The bar code reader 10 includes an imaging system 12 and a decoding system 14 mounted in a housing 16. The reader 10 is capable of reading, that is, imaging and decoding bar codes. The imaging system 12 is adapted to capture image frames of a field of view FV of the imaging system 12 arid the decoding system 14 is adapted to decode encoded indicia within a captured image frame. The housing 16 supports circuitry 11 of the reader 10 including the imaging and decoding systems 12, 14 within an interior region 17 of the housing 16.

The imaging system 12 comprises a scan engine or imaging camera assembly 20 and associated imaging circuitry 22. The imaging camera assembly 20 includes a housing 24 supporting focusing optics including one or more imaging lens 26 and a photosensor or pixel array 28. The sensor array 28 is enabled during an exposure period to capture an image of a target object 32 within a field of view FV of the imaging system 12. The field of view FV of the imaging system 12 is a function of both the configuration of the sensor array 28 and the optical characteristics of the imaging lens 26 and the distance and orientation between the array 28 and the imaging lens 26. In one exemplary embodiment, the imaging system 12 is a linear or one dimensional imaging system and the sensor array 28 is a linear or 1D sensor array.

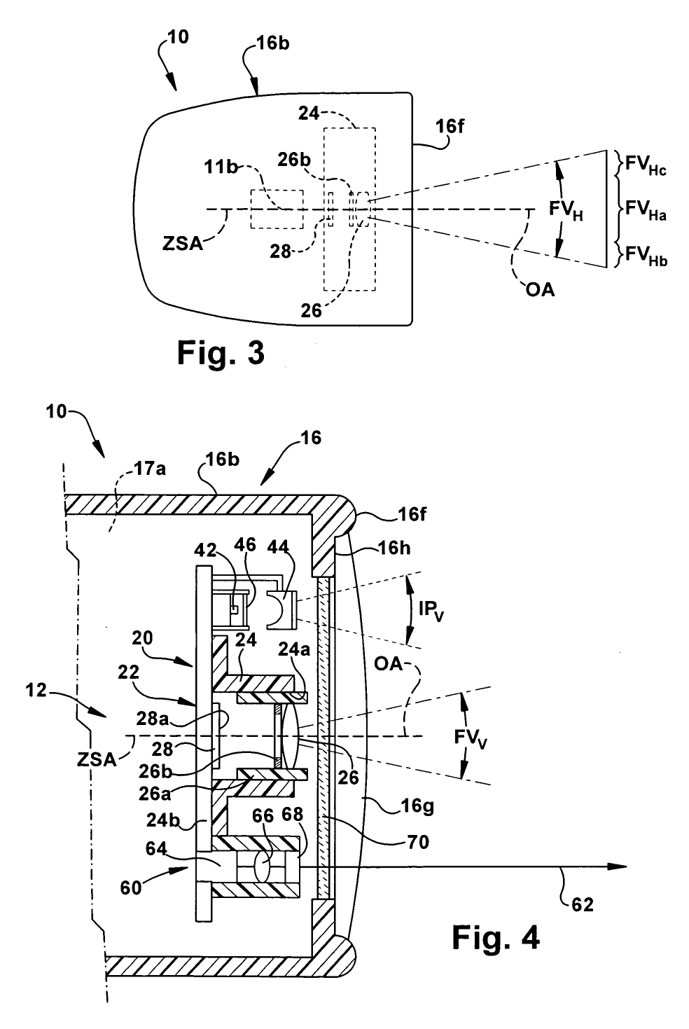

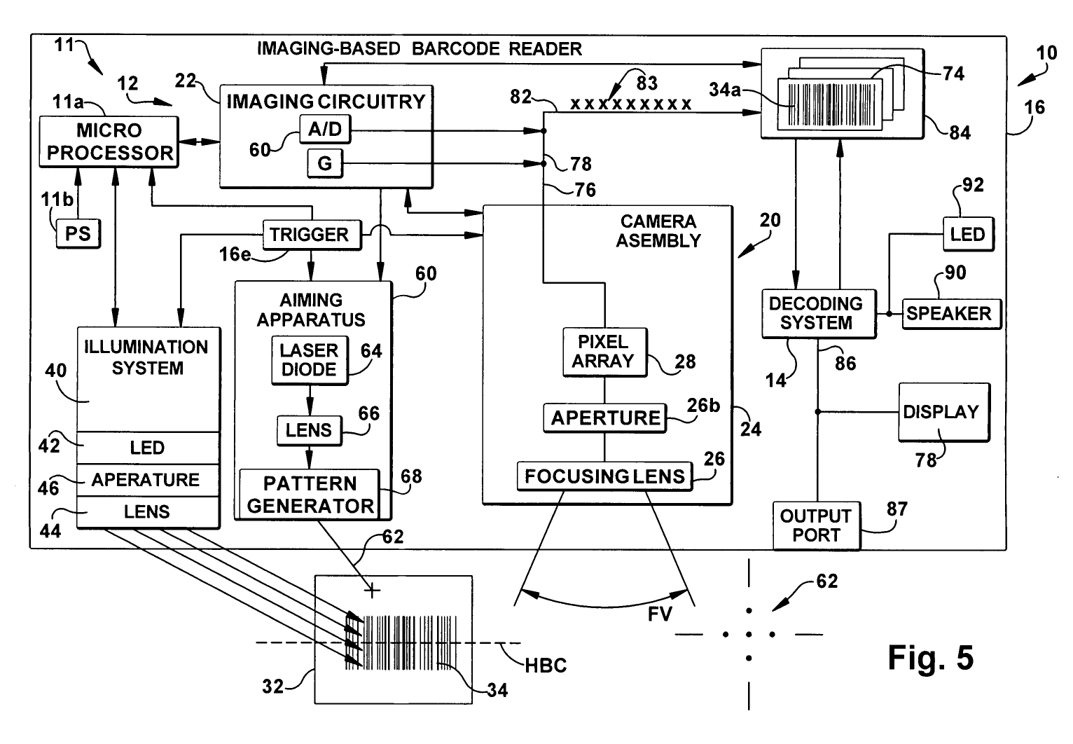

The imaging system 12 field of view FV (shown schematically in FIG. 5) includes both a horizontal and a vertical field of view, the horizontal field of view being shown schematically as FVH in FIG. 3 and the vertical field of view being shown schematically as FVV in FIGS. 1 and 4. The linear sensor array 28 is primarily adapted to image ID bar codes, for example, a UPC bar code as shown in FIG. 1 which extends along a horizontal axis HBC and includes one row of indicia, an array of dark bars and white spaces. However, one of skill in the art would recognize that the present invention is also applicable to imaging systems utilizing a 2D photosensor array to image 2D bar codes, postal codes, signatures, etc.

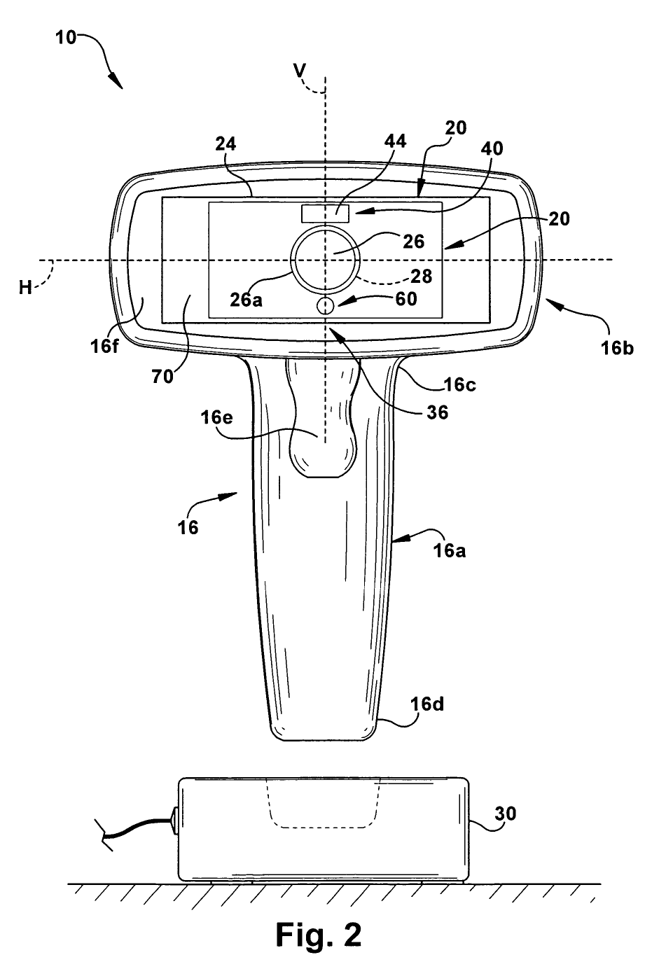

The housing 16 includes a gripping portion 16a adapted to be grasped by an operator's hand and a forward or scanning head portion 16b extending from an upper part 16c of the gripping portion 16a. A lower part 16d of the gripping portion 16a is adapted to be received in a docking station 30 positioned on a substrate such as a table or sales counter. The scanning head 16b supports the imaging system 12 within an interior region 17a (FIG. 4) of the scanning head 16b. As can best be seen in FIG. 2, looking from the front of the housing 16, the scanning head 16b is generally rectangular in shape and defines a horizontal axis H and a vertical axis V. The vertical axis V being aligned with a general extent of the gripping portion 16a.

Advantageously, the reader 10 of the present invention is adapted to be used in both a hand-held mode and a fixed position mode. In the fixed position mode, the housing 16 is received in the docking station 30 and a target object 32 having a target bar code 34 (FIG. 1) is brought within the field of view FV of the reader's imaging system 12 in order to have the reader 10 read the target bar code 34. The imaging system 12 is typically always on or operational in the fixed position mode to image and decode any target bar code presented to the reader 10 within the field of view FV. The docking station 30 is plugged into an AC power source and provides regulated DC power to circuitry 11 of the reader 10. Thus, when the reader 10 is in the docking station 30 power is available to keep the imaging system 12 on continuously.

In the hand-held mode, the housing 14 is removed from the docking station 30 so the reader 10 can be carried by an operator and positioned such that the target bar code 34 is within the field of view FV of the imaging system 12. In the hand-held mode, imaging and decoding of the target bar code 34 is instituted by the operator depressing a trigger 16e extending through an opening near the upper part 16c of the gripping portion 16a.

The imaging system 12 is part of the bar code reader circuitry 11 which operates under the control of a microprocessor 11a. When removed from the docking station 30, power is supplied to the imaging and decoding systems 12, 14 by a power supply 11b. The imaging and decoding systems 12, 14 of the present invention may be embodied in hardware, software, electrical circuitry, firmware embedded within the microprocessor 11a or the scan engine 20, on flash read only memory (ROM), on an application specific integrated circuit (ASIC), or any combination thereof.

The bar code reader 10 includes an illumination apparatus or system 40, described more fully below, to illuminate the target bar code 34 and an aiming system 60 which generates a visible aiming pattern 62 (FIG. 5) to aid the operator in aiming the reader 10 at the target bar code 34 when using the reader in the hand-held mode. The aiming system 60 generates the visible aiming pattern 62 comprising a single dot of illumination, a plurality of dots and/or lines of illumination or overlapping groups of dots/lines of illumination. The aiming system 60 typically includes a laser diode 64, a focusing lens 66 and a pattern generator 68 for generating the desired aiming pattern 62.

The camera housing 24 is supported within the scanning head interior region 17a in proximity to a transparent window 70 defining a portion of a front wall 16f of the scanning head 16b. The window 70 is oriented such that its horizontal axis is substantially parallel to the scanning head horizontal axis H and its vertical axis is substantially parallel to the scanning head vertical axis V. Reflected light from the target bar code 34 passes through the transparent window 70, is received by the focusing lens 26 and focused onto the imaging system sensor array 28. In one embodiment, the illumination apparatus 40 and the aiming assembly 60 may be positioned behind the window 70. Illumination from the illumination apparatus 40 and the aiming pattern 62 generated by the aiming assembly 60 also pass through the window 70.

The imaging circuitry 22 may be disposed within, partially within, or external to the camera assembly housing 24. The imaging lens 26 (which may be a single lens or series of lenses) are supported by a lens holder 26a. The camera housing 24 defines a front opening 24a that supports and seals against the lens holder 26a so that the only light incident upon the sensor array 28 is illumination passing through the imaging lens 26.

Depending on the specifics of the camera assembly 20, the lens holder 26a may slide in and out within the camera housing front opening 24a to allow dual focusing under the control of the imaging circuitry 22 or the lens holder 26a may be fixed with respect to the camera housing 25 in a fixed focus camera assembly. The lens holder 26a is typically made of metal. A back end of the housing 24 may be comprised of a printed circuit board 24b, which forms part of the imaging circuitry 22 and extends vertically to also support the illumination apparatus 40 and the aiming apparatus 60 (best seen in FIG. 4).

The imaging system 12 includes the linear sensor array 28 of the imaging camera assembly 20. The sensor array 28 comprises a charged coupled device (CCD), a complementary metal oxide semiconductor (CMOS), or other imaging pixel array, operating under the control of the imaging circuitry 22. In one exemplary embodiment, the sensor array 28 comprises a linear pixel CCD or CMOS array with a one row of pixels. The number of pixels in the row typically would be 512, 1024, 2048 or 4096 pixels. The typical size of a pixel in the pixel array would be on the order of 7 microns in horizontal width ×120 microns in vertical height.

The illumination-receiving pixels of the pixel array define a sensor array surface 28a (best seen in FIG. 4). The pixel array 28 is secured to the printed circuit board 24b, in parallel direction for stability. The sensor array surface 28a is substantially perpendicular to an optical axis OA of the focusing lens 26, that is, a z axis (labeled ZSA in FIG. 4) that is perpendicular to the sensor array surface 28a would be substantially parallel to the optical axis OA of the focusing lens 26. The pixels of the sensor array surface 28a are disposed substantially parallel to the horizontal axis H of the scanning head 16b.

As is best seen in FIG. 4, the focusing lens 26 focuses light reflected and scattered from the target bar code 34 through an aperture 26b onto the sensor array surface 28a of the pixel/photosensor array 28. Thus, the focusing lens 26 focuses an image of the target bar code 34 (assuming it is within the field of view FV) onto the array of pixels comprising the pixel array 28. When actuated to read the target bar code 34, the imaging system 12 captures a series of image frames 74 which are stored in a memory 84. Each image frame 74 includes an image 34a of the target bar code 34 (shown schematically in FIG. 5). The decoding system 14 decodes a digitized version of the image bar code 34a.

Electrical signals are generated by reading out of some or all of the pixels of the pixel array 28 after an exposure period. After the exposure time has elapsed, some or all of the pixels of pixel array 28 are successively read out thereby generating an analog signal 76 (FIG. 4). In some sensors, particularly CMOS sensors, all pixels of the pixel array 28 are not exposed at the same time, thus, reading out of some pixels may coincide in time with an exposure period for some other pixels.

The analog image signal 76 represents a sequence of photosensor voltage values, the magnitude of each value representing an intensity of the reflected light received by a photosensor/pixel during an exposure period. The analog signal 76 is amplified by a gain factor, generating an amplified analog signal 78. The imaging circuitry 22 further includes an analog-to-digital (A/D) converter 80. The amplified analog signal 78 is digitized by the A/D converter 80 generating a digitized signal 82. The digitized signal 82 comprises a sequence of digital gray scale values 83 typically ranging from 0-255 (for an eight bit processor, i.e., 2⁸=256), where a 0 gray scale value would represent an absence of any reflected light received by a pixel during an exposure or integration period (characterized as low pixel brightness) and a 255 gray scale value would represent a very high intensity of reflected light received by a pixel during an exposure period (characterized as high pixel brightness).

The digitized gray scale values 83 of the digitized signal 82 are stored in the memory 84. The digital values 83 corresponding to a read out of the pixel array 28 constitute the image frame 74, which is representative of the image projected by the focusing lens 26 onto the pixel array 28 during an exposure period. If the field of view FV of the focusing lens 26 includes the target bar code 34, then a digital gray scale value image 34a of the target bar code 34 would be present in the image frame 74.

The decoding circuitry 14 then operates on the digitized gray scale values 83 of the image frame 74 and attempts to decode any decodable image within the image frame, e.g., the imaged target bar code 34′. If the decoding is successful, decoded data 86, representative of the data/information coded in the bar code 34 is then output via a data output port 87 and/or displayed to a user of the reader 10 via a display 88. Upon achieving a good “read” of the bar code 34, that is, the bar code 34 was successfully imaged and decoded, a speaker 90 and/or an indicator LED 92 is activated by the bar code reader circuitry 13 to indicate to the user that the target bar code 34 has successfully read, that is, the target bar code 34 has been successfully imaged and the imaged bar code 34a has been successfully decoded. If decoding is unsuccessful, a successive image frame 74 is selected and the decoding process is repeated until a successful decode is achieved.

### Illumination Apparatus

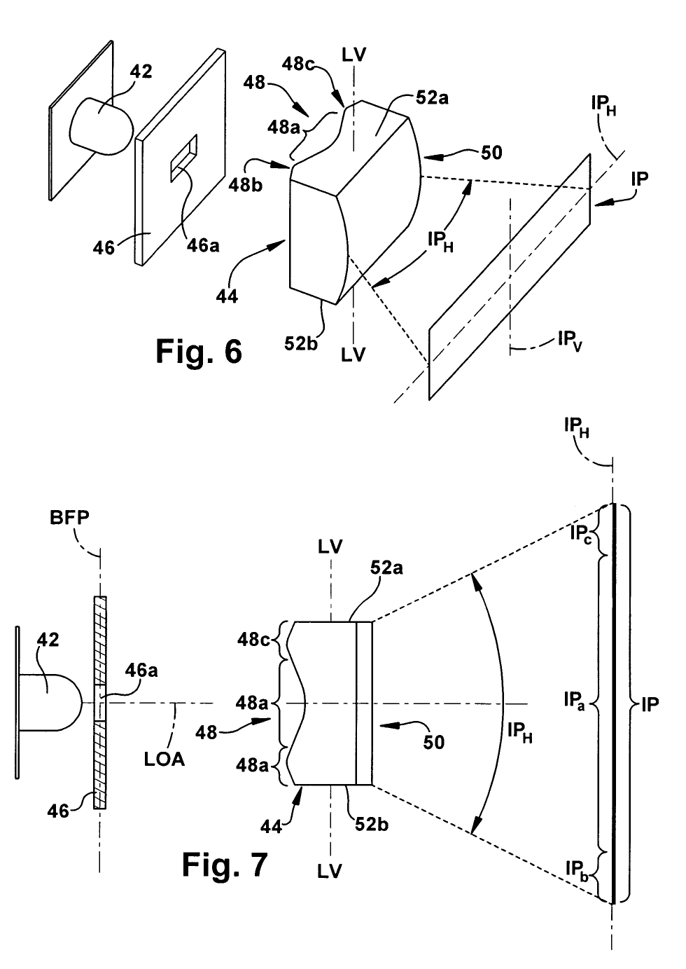

As can be seen in FIGS. 6 and 7, the illumination apparatus or system 40 of the present invention includes one or more illumination sources 42 such as an LED, such as a surface mount LED, or a cold cathode lamp (CFL) which is energized to direct illumination though a focusing lens 44 and generate an illumination pattern IP that fills or substantially coincides with the field of view FV of the imaging system 12. In the exemplary embodiment shown in FIG. 6 and 7, the illumination pattern IP is generally a very narrow rectangle in shape with its longitudinal axis in the horizontal direction and a very narrow vertical or height dimension. This illumination pattern IP is adapted to be used in conjunction with a bar code reader having a linear sensor array for reading 1D bar codes which are generally narrow and rectangular in shape. The imaging system field of view FV would also be generally narrow and rectangular in shape. For a bar code reader embodiment adapted to reader 2D bar codes, the illumination pattern IP and field of view FV would be generally rectangular, but wider in vertical dimension to account for the typically greater height or vertical dimension of a 2D bar code. An aperture 46 defining a generally rectangular opening 46a is positioned between the LED 42 and the focusing lens 44. The aperture 46 limits the light or illumination from the LED focused onto the focusing lens 44. The focusing lens 44 images or projects the rectangular shape of the aperture 46 toward the target object 32 thus defining the illumination pattern IP. The aperture 46 is in proximity to the focal plane of the focusing lens 44. The light from the aperture opening 46a is collected and focused by the focusing lens 44. A vertical size or dimension of the aperture 46 determines the vertical extent IPV of the illumination pattern IP projected on the target object 32.

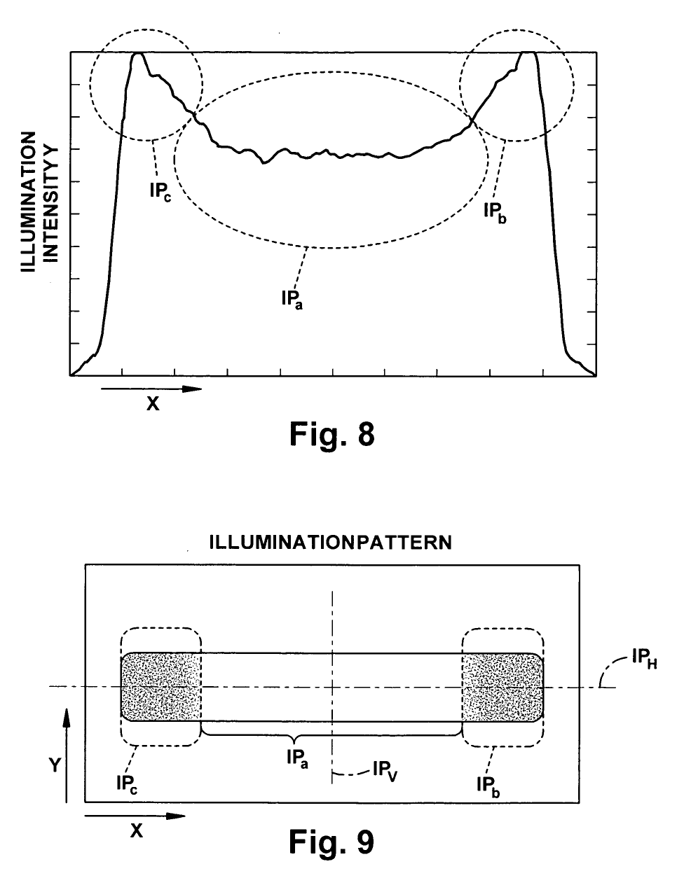

The focusing lens 44 includes a first or rearward facing optical surface 48 facing the LED 42 and a second or forward facing optical surface 50 facing the window 70 and the target bar code 34. Advantageously, as is best seen in FIGS. 8 and 9, the illumination system 40 and, particularly, the focusing lens 44 of the present invention provides an illumination pattern IP that includes relatively less intensity of illumination in a central portion or region IPa of the pattern and a relatively greater illumination intensity in the outlying horizontal peripheral edge portions IPb, IPc of the pattern. In other words, with respect to a horizontal axis IPH of the illumination pattern IP, which corresponds to the horizontal field of view FVH of the imaging system 12 and the horizontal axis H of the scanning head 16b, the horizontal edge portions IPb, IPc of the illumination pattern IP, corresponding to the edge portions FVHb, FBHc (FIG. 3) of the horizontal field of view FVH, have a greater illumination intensity than a central portion FVHa of the horizontal field of view. Illumination intensity may be measured in, for example, lumens.

The desired non-uniform illumination pattern IP is generated by the illumination system focusing lens 44 and particularly, the inwardly facing optical surface 48. Specifically, with respect to a horizontal axis LH of the lens 44, the rearward facing optical surface 48 includes a central region or area 48a (FIGS. 6 and 7) having a concave curvature which defines a negative optical power. This negative optical power tends to diffuse the illumination from the LED 42 passing though the central region 48a. The edge or peripheral regions 48b, 48c of the inwardly facing optical surface 48 have a convex curvature which defines a positive optical power. Stated another way, the optical power of peripheral regions 48b, 48c is greater in positive magnitude than the optical power of the central region 48a.

The positive power of peripheral regions 48b, 48c tends to focus the illumination from the LED 42 passing through the peripheral regions with the result that the horizontal peripheral portions IPb, IPc of the illumination pattern IP have a net greater illumination intensity than the central portion IPa. The curvatures of the regions 48a-48c remain substantially constant with respect to the vertical axis LV (FIG. 6) of the lens 44, that is, from a top end 52a to a bottom end 52b of the lens.

The optical powers of the central region 48a and the peripheral regions 48b, 48c will be determined by, among other things, the optical properties of the imaging system including the imaging lens 26, the characteristics of the target bar code 34 desired to be read, the ambient lighting conditions, environmental condition, the LED 42 and aperture 46 utilized, etc.

The surface profile of the rearward facing optical surface 48 is aspherical cylindrical, that is it does not have a constant radius of curvature across the optical surface 48 as a cylindrical surface would. The optical surface 48 may be conveniently viewed in terms of a cylinder and surface sag (or surface profile) in the peripheral regions. Surface sag is the surface profile of the aspherical surface while residual surface sag is the difference in depth between a spherical and an aspherical surface. The surface profile of the central region 48a is substantially cylindrical, i.e., has the shape of a portion of a vertically oriented cylinder. This concave central region 48a causes diverging illumination as expected of a negative power concave optical surface or element. The peripheral regions 48b, 48c, however, deviate from the cylindrical surface profile of the central region 48a and exhibit surface sag. This surface sag of the peripheral regions 48a, 48b functions as a positive power optical element. The surface profile of the central region 48a and the peripheral regions 48b, 48c is constant when viewed with respect to the vertical axis LV of the lens 44. Stated another way, there is no curvature of the optical surface 48 in the vertical direction or in the vertical plane.

Specific details and formulas regarding aspherical optical surfaces may be found in Modem Optical Engineering—The Design of Optical Systems (Third Edition), by Warren J. Smith, published by McGraw-Hill Professional, date of publication Jul. 26, 2000, ISBN 0-07-136360-2. The aforementioned Modern Optical Engineering book is incorporated herein in its entirety by reference. One aspheric optical surface formula that is useful is the following:

z(y)=[cy²/(1+(1−c²y²)^{1/2})]+α₁y²+α₂y⁴+α₃y⁶+ . . . +α_{N}y^{2*N}

wherein: z is the surface sag or surface profile of the aspheric surface; y is the y coordinate of the aspheric surface with z being a function of y; c is the surface curvature (c=1/R, where R is the radius of the surface); and N is the number of aspherical terms. This is a modified formula for an aspheric optical surface found on page 312 of the aforementioned Modem Optical Engineering book. Here, for the optical surface 48, there are two aspherical terms (N=2) and reasonable coefficients for α₁and α₂would be approximately:

α₁=−0.3 ×10⁻¹ mm⁻¹and α₂=+0.04 ×10⁻³ mm⁻³.

It should be noted that illumination intensity across a vertical axis IPV of the illumination pattern IP does not vary substantially due to the fact that, in this particular embodiment, the sensor array 28 is a horizontally-oriented, linear or ID sensor array. Thus, variation of illumination pattern across the vertical axis is not required. If the sensor array 28 were a 2D sensor array, then the illumination pattern IP would be appropriately modified to provide greater illumination intensity in the peripheral or edge regions along both the horizontal and vertical axis.

The forward facing optical surface 50 focuses light in the vertical direction IPV of the illumination pattern IP. In one exemplary embodiment, the forward optical surface 50 may be an aspherical cylindrical optical surface whose longitudinal axis is substantially parallel to the horizontal axis LH of the lens 44. In the lens 44, the rearward facing optical surface 48 redistributes the illumination system light in a horizontal direction and the forward facing surface 50 focuses the light into a line in the vertical direction. Preferably, the back focal plane BFP (FIG. 7) of the focusing lens 44 is substantially congruent with a location of the aperture 46 along an optical axis LOA of the lens 44.

By way of example and without limitation, the lens 44 may have a lens focal number (F#) in the vertical plane of approximately 2. This focal number is primarily determined by the stronger optical power of the cylindrical forward facing optical surface 50. If one were to slice the illumination pattern IP in the vertical plane, the pattern would be very sharp, however, in the horizontal plane, the illumination pattern would be wide and blurry. Therefore, with respect to the horizontal plane, it is difficult to define a focal distance or focal number.

A representative plot of illumination intensity taken across the horizontal axis IPH of the illumination pattern IP is shown in FIG. 8. As can be seen in FIG. 8, the illumination intensity of the horizontal edge portions IPb, IPc exceeds the illumination intensity of central portion IPa. This change in illumination intensity may also be seen in the schematic depiction of illumination intensity of the illumination pattern IP in FIG. 9. In FIG. 9, the peripheral portions IPb, IPc have a darker shade indicative of greater illumination intensity than the central portion IPa of the illumination pattern IP. As can also be seen, the peripheral portion IPb, IPc are vertically oriented, that is, they are substantially orthogonal to the illumination pattern horizontal axis IPH.

The illumination pattern IP produced by the illumination system 40 of the present invention compensates for the fact that the focusing lens 26 of the imaging system 12 tends to collect and focus a greater portion of reflected light from the central area FVHa of the horizontal field of view FVH onto the pixel array 28 than is collected and focused from the horizontal fringe areas FVHb, FVHc. Without the compensation provided by the variation in fringe area intensity illumination of the present invention what would occur is that pixels of the pixel array 28 corresponding to horizontal outer fringes FVHb, FVHc of the FOV would receive a lower intensity of reflected light than a pixel in a central region of the pixel array. This would tend to cause changes or fluctuation of the output analog signal 76 read out from the pixel array based on the relative position of a pixel in the pixel array 28. Non-uniformity of the analog signal 76 tends to reduce the dynamic range of the imaging system 12 and compromises reader performance. The illumination system 40 of the present invention tends to generate a uniform reflected illumination intensity focused across an extent of the linear photosensor array 28, taking into account, of course, the differences in reflected illumination intensity that results from the pattern of black bars and white spaces of the target bar code 34. Stated another way, if the illumination pattern IP was directed to a uniformly white target area, the intensity of reflected illumination intensity focused across the extent of the photosensor array 28 would be substantially constant or uniform.

### Second Exemplary Embodiment of Illumination Apparatus

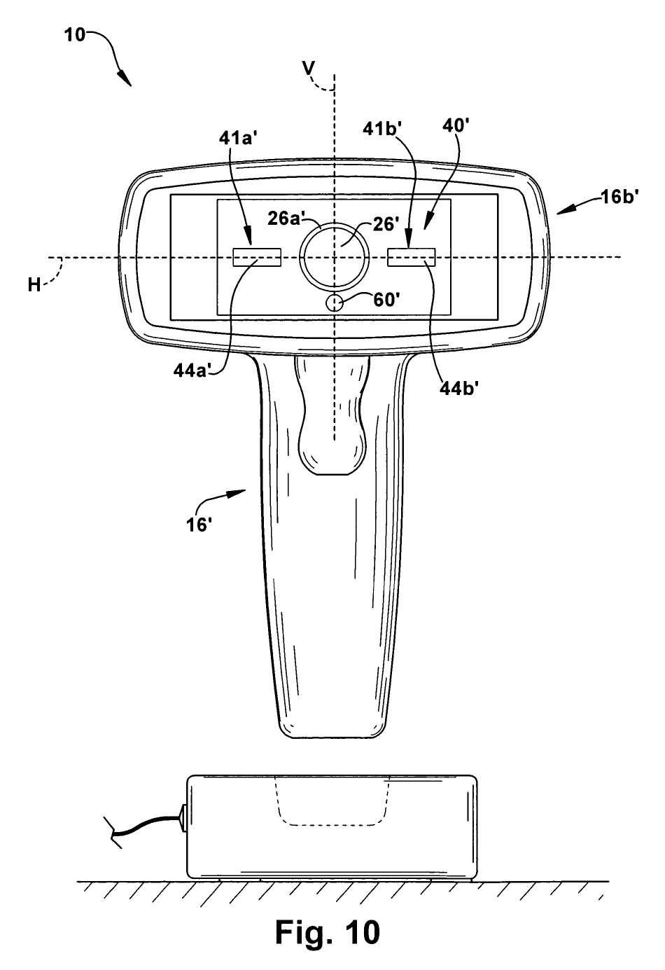

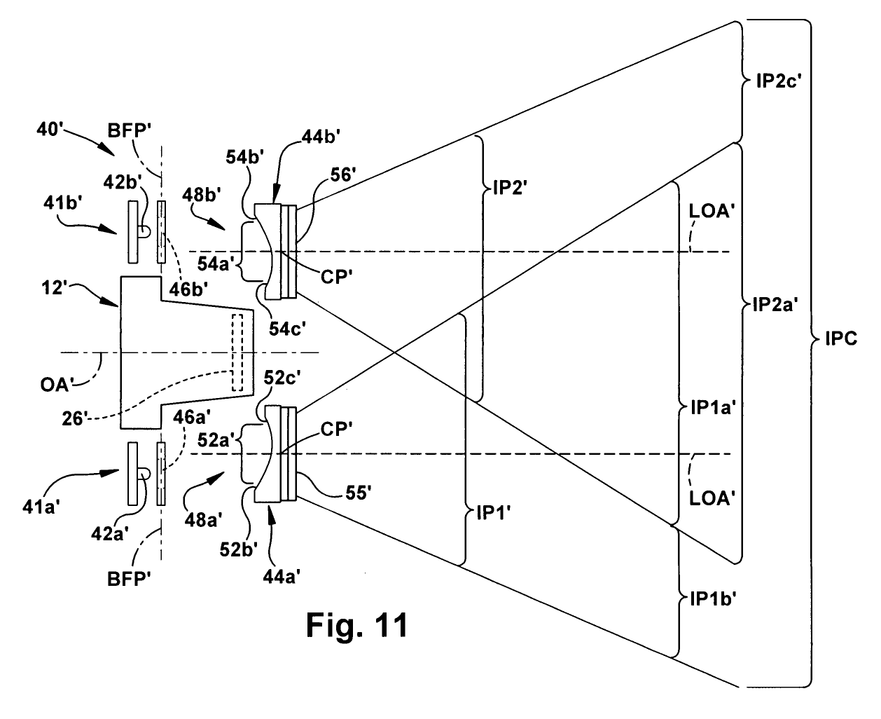

Another exemplary illumination apparatus or system is shown as 40′ in FIGS. 10-13. The remaining components of the reader 10′ are the same as described above with respect to the reader 10 and will not be repeated. The illumination system 40′ of this embodiment is a dual illumination assembly, that is, there are two illumination assemblies 41a′, 41b′, each including a combination of an LED 42a′, 42b′ and a focusing lens 44a′, 44b′, respectively. As best seen in FIG. 11, the illumination assemblies 41a′, 41b′ are horizontally aligned and disposed on opposite sides of an optical axis OA′ of an imaging lens 26′ of the imaging system 12′. Specifically, the first illumination assembly 41a′ includes the combination of the LED 42a′, the lens 44a′, and an aperture 46a′ disposed at the back focal plane BFP′ of the lens 44a′ between the LED 42a′ and the lens 44a′ adjacent the LED 42a′ to pass or direct the LED illumination toward the lens 44a′. The positioning of the aperture 46a′ at the back focal plane BFP′ of the lens 44a′ achieves, when viewed in the vertical plane, a sharp or focused illumination pattern. As mentioned before, when viewed in the horizontal plane, the illumination pattern is relatively blurry.

The second illumination assembly 41b′ includes the combination of the LED 42b′, the lens 44b′, and an aperture 46b′ disposed at the back focal plane BFP′ of the lens 44b′ between the LED 42b′ and the lens 44b′ adjacent the LED 42b′to pass or direct the LED illumination toward the lens 44b′.

As can best be seen in FIG. 11, there is a horizontal offset between the respective LEDs 42a′, 42b′ and an optical axis LOA′ or horizontal center point CP′ of the respective lens 44a′, 44b′. Stated another way, the focusing apertures 46a′, 46b′ are horizontally offset from the center point CP′ of the respective lens 44a, 44b′. As can also be seen, the rearward facing optical surfaces 48a′, 48b′ of the lens 44a′, 44b′are non-symetric horizontally about the central optical axis LOA′. As can best be seen in FIGS. 11-14, for lens 44a′, there is a rearward facing optical surface 48a′, with respect to the lens horizontal axis, including a central region 52a′ and a pair of peripheral regions 52b′, 52c′ and for lens 44b , there is a rearward facing optical surface 48b′, with respect to the lens horizontal axis, including a central concave region 54a′ and a pair of peripheral convex regions 54b′, 54c′.

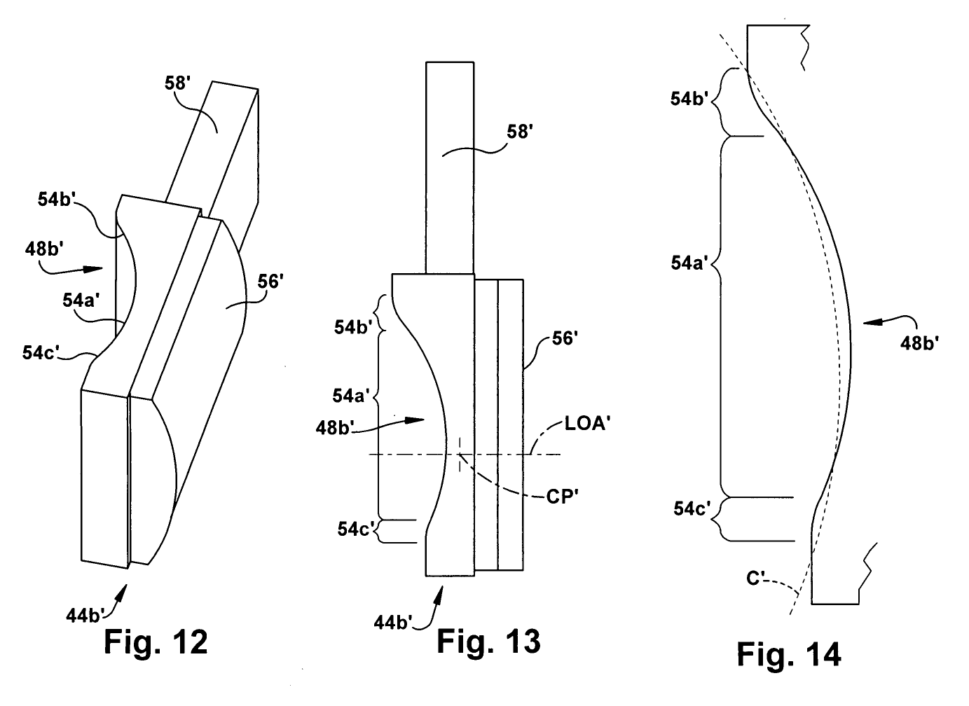

The lens 44a′ and 44b′ are substantially mirror images of each other. Thus, what is said about one applies equally to the other. With respect to lens 44b′, as can best be seen FIG. 14, the aspheric rearward optical surface 48b′ can best be visualized with respect to a superimposed a large virtual best fit cylinder with a peripheral curvature C′. When the virtual best fit cylinder having curvature C′ is removed, the central region 54a′ of the rearward optical surface 48b′ is concave with a negative residual sag with respect to the cylinder concave curvature C′, that is, the surface profile of the lens 48a′ falls below the curvature C′. The residual profile of the central region 54a′ is concave with respect to the concave curvature C′ or, stated another way, with respect to the concave curvature C′, the central region 54a′ is residually concave and has a negative residual optical power.

The peripheral region 54b′ is convex with a positive residual sag with respect the curvature C′, that is, the surface profile of the lens 48a′ rises above the curvature C′. The residual profile of the peripheral region 54b′ is convex with respect to the concave curvature C′ or, stated another way, with respect to the concave curvature C′, the peripheral region 54b′ is residually convex and has a positive residual optical power. By way of example only and not for limitation, if, for example, the optical power of the curvature C is −2.0, the optical power of the central region 54a′ may be −2.2 which would result in a residual negative optical power of the central region 54a′ of −0.2 with respect to the best fit cylinder having a curvature C′. Continuing the example, the optical power of the peripheral region 54b′ may be −0.5 which would result in a residual positive optical power of the peripheral region of +1.5 with respect to the best fit cylinder having a curvature C′. Thus, even through the optical power of the peripheral region 54b′ is negative, the residual optical power is positive, in the same way, it is possible that the actual profile of the peripheral region 54b′ would concave even though the residual profile with respect to the best fit cylinder curvature C is convex.

Finally, the peripheral region 52c′ is a very small convex region with a positive residual sag with respect to the curvature C′. The residual profile of the peripheral region 54c′ is convex with respect to the concave curvature C′ or, stated another way, with respect to the concave curvature C′, the peripheral region 54c′ is residually convex and has a positive residual optical power.

In forming the lens 44a′, 44b′, the respective second convex surfaces 52c′ 54c′ are chopped such that the respective first convex surfaces 52b′, 54b′ extend rearward to a greater extent than the respective second convex surfaces 52c′, 54c′. Thus, the optical power of regions 52b′, 54b′ are greater in positive optical power magnitude than the optical powers of regions 52c′, 54c′ and the optical powers of regions 54c′, 54c′ are greater in positive optical power magnitude than the optical powers of regions 52a′, 54a′. Stated another way, the residual optical power in the central region 52a′ is negative and in the peripheral regions 52b′, 52c′ the residual optical power is positive. The concave shape of the central region 52a′, 54b′ are generally cylindrical with aspherical convex peripheral regions 52b′, 52c′, 54b′, 54c′. The surface profile of the central regions 52a ′, 54a′ and the peripheral regions 52b′, 52c′, 54b′, 54c′ are constant when viewed with respect to the vertical axis of the lens 44a′, 44b′. Stated another way, there is no curvature of the optical surface 48a′, 48b′ in the vertical direction or in the vertical plane.

The result of the offset between the LED 42a′ and the lens 44a′ and the non-symmetrical shape of the rearward facing optical surface 48a′ is an illumination pattern IP1′ (FIG. 11). In the illumination pattern IP1′, a right peripheral portion IP1b′ has a greater illumination intensity than the remainder of the pattern, namely, portion IP1a′.

As described above, the lens 44b′ is a mirror image of the lens 44a′ and includes the rearward facing optical surface 48b′. The optical surface 48b′ includes a central concave region 54a′ having a negative residual optical power and a pair of peripheral convex regions 54b′, 54c′ having positive residual optical powers. In forming the lens 44b′, the second convex surface 54b′ is chopped such that the first convex surface 54c′ extends rearward to a greater extent than the second convex surface 54b′. Thus, the positive optical power of region 54c′ is greater in optical power than the positive optical power of region 54b′. The rearward facing optical surface 48b′ of the lens 44b′ is nonsymetric about the optical axis LOA′.

The result of the offset between the LED 42b′ and the lens 44b′ and the non-symmetrical shape of the rearward facing optical surface 48b′ is an illumination pattern IP2′ wherein a left peripheral portion IP2c′ has a greater illumination intensity than the remainder of the pattern, namely, portion IP2a′.

The two illumination patterns IP1′, IP2′ are directed such that they overlap to produce a composite or combined illumination pattern IPC, that is similar in illumination intensity pattern to the pattern IP discussed in the first embodiment above, namely, when viewed with respect to a horizontal axis of the illumination pattern, the central portion has less illumination intensity than the peripheral portions.

The forwardly facing optical surface 56′ of the lens 44a′, 44b′ is preferably an aspherical cylindrical lens as described in the first embodiment. The lens 44a′, 44b′ includes a support arm 58′ which is used to support and position the lens, but is not part of the lens optics. The flat portions of the rearward facing optical surfaces 48a′, 48b′ extending outwardly from 52a′, 52b′, 54a′, 54b′ are also not part of the lens optics.

While the illumination apparatus 40 includes one illumination assembly and the illumination system 40′ includes two illumination assemblies, it should be recognizes that one, three, four or any number of illumination assemblies may be utilized depending upon the illumination requirements of the target bar code 34, the imaging system 12, and the environmental conditions that the reader 10 is being used under. Further, depending on the characteristics of the light source (LED or cold cathode lamp), a focusing aperture disposed between the light source and the focusing lens may or may not be required or advantageous. Similarly, the number of LEDs focused through a given aperture may vary as well.

While the present invention has been described with a degree of particularity, it is the intent that the invention includes all modifications and alterations from the disclosed design falling with the spirit or scope of the appended claims.

I claim:

1. An illumination apparatus for an imaging-based bar code reader comprising:
an illumination source directing illumination through a focusing lens to generate an illumination pattern directed toward a target object; and
the focusing lens including a first optical surface, the first optical surface including a central region having concave curvature and peripheral regions spaced on opposite sides of the central region having convex curvature such that the generated illumination pattern includes variation in illumination intensity.

2. The illumination apparatus of claim 1 wherein the first optical surface of the focusing lens faces the illumination source and a second optical surface of the focusing lens faces the target object.

3. The illumination apparatus of claim 1 wherein the generated illumination pattern includes variation in illumination intensity projected toward the target object such that a central portion of the illumination pattern has relatively lower illumination intensity and outer peripheral portions of the illumination pattern on opposite sides of the central portion have relatively higher illumination intensity.

4. The illumination apparatus of claim 1 wherein the illumination source is an LED.

5. The illumination apparatus of claim 2 wherein the wherein the second optical surface is an aspherical cylindrical optical surface.

6. The illumination apparatus of claim 1 wherein the focusing lens defines a horizontal axis and the illumination pattern is substantially rectangular having a horizontal axis that is substantially parallel to the horizontal axis of the focusing lens and wherein the peripheral regions of the first optical surface are spaced outwardly along the horizontal axis from the central region and further wherein outer peripheral portions of the illumination pattern are spaced outwardly from the central portion and are substantially orthogonal to the horizontal axis of the illumination pattern.

7. The illumination apparatus of claim 2 wherein an aperture is disposed between the illumination source and the focusing lens passing illumination from the illumination source toward the focusing lens.

8. The illumination apparatus of claim 7 wherein the second optical surface is an aspherical surface having a back focal plane substantially congruent with the aperture.

9. The illumination apparatus of claim 1 wherein the illumination source is offset horizontally from an optical axis of the focusing lens.

10. An imaging-based bar code reader comprising:
an imaging system including a lens and a photosensor array for focusing reflected illumination from a target object onto the photosensor array;
an illumination system including an illumination source directing illumination through a focusing lens to generate an illumination pattern directed toward the target object; and
the focusing lens including a first optical surface, the first optical surface including a central region having concave curvature and peripheral regions spaced on opposite sides of the central region having convex curvature such that the generated illumination pattern includes variation in illumination intensity.

11. The imaging-based bar code reader of claim 10 wherein the first optical surface of the focusing lens faces the illumination source and a second optical surface of the focusing lens faces the target object.

12. The imaging-based bar code reader of claim 10 wherein the generated illumination pattern includes variation in illumination intensity projected toward the target object such that a central portion of the illumination pattern has relatively lower illumination intensity and outer peripheral portions of the illumination pattern on opposite sides of the central portion have relatively higher illumination intensity.

13. The imaging-based bar code reader of claim 10 wherein the photosensor array is a 1D photosensor array and the target object is a 1D bar code.

14. The imaging-based bar code reader of claim 10 wherein the illumination source is an LED.

15. The imaging-based bar code reader of claim 11 wherein the wherein the second optical surface is an aspherical cylindrical optical surface.

16. The imaging-based bar code reader of claim 10 wherein the focusing lens defines a horizontal axis and the illumination pattern is substantially rectangular having a horizontal axis that is substantially parallel to the horizontal axis of the focusing lens and wherein the peripheral regions of the first optical surface are spaced outwardly along the horizontal axis from the central region and further wherein outer peripheral portions of the illumination pattern are spaced outwardly from the central portion and are substantially orthogonal to the horizontal axis of the illumination pattern.

17. The imaging-based bar code reader of claim 11 wherein an aperture is disposed between the illumination source and the focusing lens passing illumination from the illumination source toward the focusing lens.

18. The imaging-based bar code reader of claim 17 wherein the second optical surface is an aspherical surface having a back focal plane substantially congruent with the aperture.

19. The imaging-based bar code reader of claim 10 wherein the illumination source is offset horizontally from an optical axis of the focusing lens.

20. A method of imaging a target object, the step of the method including:
providing an imaging system including a lens and a photosensor array for focusing reflected illumination from a target object onto the photosensor array;
providing an illumination system including an illumination source directing illumination through a focusing lens to generate an illumination pattern directed toward the target object, the focusing lens including a first optical surface, the first optical surface including a central concave region and peripheral convex regions spaced on opposite sides of the central region such that the generated illumination pattern includes variation in illumination intensity; and
energizing the illumination system and the imaging system and imaging the target object.

21. An illumination apparatus for an imaging-based bar code reader comprising:
illumination means for directing illumination through a focusing means to generate an illumination pattern directed toward a target object; and
the focusing means for generating the illumination pattern wherein the illumination pattern includes variation in illumination intensity projected toward the target object such that a central portion of the illumination pattern has relatively lower illumination intensity and outer peripheral portions of the illumination pattern on opposite sides of the central portion have relatively higher illumination intensity.

22. An illumination system for an imaging-based bar code reader including an imaging system, the illumination system comprising:
a first illumination assembly and a second illumination assembly, each of the first and second assemblies including an illumination source and a focusing lens, the illumination source directing illumination through the focusing lens and the first and second illumination assemblies together generating an illumination pattern directed toward a target object, the illumination pattern including variation in illumination intensity;
the first assembly being on one side of an optical axis of the imaging system and the second assembly being on the opposite side of the optical axis of the imaging system; and for each of the first and second assemblies, the focusing lens includes a first optical surface, the first optical surface including a first region having a residual surface profile that is concave with respect to a curvature of a best fit cylinder of the focusing lens and a second region that is convex with respect to the curvature of the best fit cylinder.

23. The illumination system of claim 22 wherein the illumination pattern includes a central portion and outer peripheral portions on opposite sides of the central portion and for each of the first and second assemblies, a center point of the focusing lens is offset from the illumination source such that one of the outer peripheral area receives relative greater illumination intensity from the first assembly and the other of the outer peripheral areas receives a greater illumination intensity from the second assembly.

24. An illumination apparatus for an imaging-based bar code reader comprising:
an illumination source directing illumination through a focusing lens to generate an illumination pattern directed toward a target object; and
the focusing lens including a first optical surface, the first optical surface including a central region defining a first optical power and a peripheral region spaced from the central region defining a second optical power, the second optical power being a more positive optical power than the first optical power and the generated illumination pattern including variation in illumination intensity.

25. The illumination apparatus of claim 24 wherein the first optical surface of the focusing lens faces the illumination source and a second optical surface of the focusing lens faces the target object.
